(19) United States
(12) Patent Application Publication
(10) Pub. No.: US 2008/0303644 A1
(43) Pub. Date: Dec. 11, 2008

(54) Sounder Assembly for a personal alert safety system

(75) Inventor: Jeffrey L. Landis, Waxhaw, NC (US)

Correspondence Address: Rick Comoglio;Tyco International Ltd., One Town Center Road, Boca Raton, FL, 33486, US

(73) Assignee: Scott Technologies, Inc.

(21) Appl. No.: 11/811,192

(22) Filed: Jun. 7, 2007

(51) Int. Cl. G08B 3/10

(52) U.S. Cl. 340/384.6

(57) ABSTRACT

A sounder assembly is provided for a personal alert safety system (PASS). The sounder assembly includes a housing and a piezoelectric assembly compressively held in the housing such that a sound chamber is defined by the housing and the piezoelectric assembly. The housing radially expands and contracts relative to the piezoelectric assembly based on temperature changes.

### BACKGROUND OF THE INVENTION

The present invention relates generally to safety equipment for fireman and emergency workers in hazardous environments, and more particularly to a sounder assembly for use as an alarm in a personal alert safety system (PASS).

A PASS is sometimes carried by a firefighter or other worker to detect immobilization or incapacitation thereof. The PASS typically generates an audible alarm when the firefighter or worker is immobilized, incapacitated, and/or calls for help. For example, the PASS may generate an audible alarm when the firefighter or worker activates an alarm button on the PASS, when the firefighter or worker has not moved in a predetermined amount of time, and/or when the pressure of the firefighter or worker's supply of breathable air falls below a predetermined threshold.

To generate the audible alarm, some known PASS's include one or more sounder assemblies having a piezoelectric assembly that oscillates to generate the alarm sound. However, PASS's are often used by firefighters or workers that are exposed to relatively high temperature environments, such as, but not limited to, environments of up to 260° C. The piezoelectric assembly is typically bonded to the housing and includes a piezoelectric member that is typically fabricated from a different material than other portions of the sounder assembly, such as, but not limited to, a housing of the assembly and/or a support member of the piezoelectric assembly that supports the piezoelectric member within the housing. The different materials of the different components of the sounder assembly may have different thermal coefficients of expansion. Accordingly, when the sounder assembly is exposed to the relatively high temperature environment, the different components of the sounder assembly may expand at different rates, which may cause the sounder assembly to operate differently and/or fail. For example, if the housing expands at a greater rate than the piezoelectric assembly, the tension across the piezoelectric assembly may change, which may cause the sound output of the sounder assembly to change. Moreover, and for example, if the difference between the expansion rate of the support member and the piezoelectric member is large enough, the piezoelectric member may fracture, which may cause the sounder assembly to fail to generate the audible alarm.

There is a need for a sounder assembly for a PASS that may be able to operate in higher temperature conditions than at least some known sounder assemblies.

### BRIEF DESCRIPTION OF THE INVENTION

In one embodiment, a sounder assembly is provided for a personal alert safety system (PASS). The sounder assembly includes a housing and a piezoelectric assembly compressively held in the housing such that a sound chamber is defined by the housing and the piezoelectric assembly. The housing radially expands and contracts relative to the piezoelectric assembly based on temperature changes.

In another embodiment, a personal alert safety system (PASS) includes a processor and at least one of a pressure sensor and a motion sensor. The sensor is operatively connected to the processor. A sounder assembly includes a housing and a piezoelectric assembly held by the housing such that a sound chamber is defined by the housing and the piezoelectric assembly. The piezoelectric assembly is operatively connected to the processor for receiving a voltage therefrom. The housing radially expands and contracts relative to the piezoelectric assembly based on temperature changes.

### BRIEF DESCRIPTION OF THE DRAWINGS

FIG. 1 is a perspective view of an exemplary embodiment of an integrated system carried by a firefighter or another emergency services worker.

FIG. 2 is a block diagram of an exemplary embodiment of a personal alert safety system (PASS) of the system shown in FIG. 1.

FIG. 3 is a top perspective view of an exemplary embodiment of a sounder assembly of the PASS shown in FIGS. 1 and 2.

FIG. 4 is a bottom plan view of the sounder assembly shown in FIG. 3.

FIG. 5 is an exploded perspective view of the sounder assembly shown in FIGS. 3 and 4.

FIG. 6 is a cross section of a portion of the sounder assembly shown in FIGS. 3-5 taken along the line 6-6 of FIG. 4.

### DETAILED DESCRIPTION OF THE INVENTION

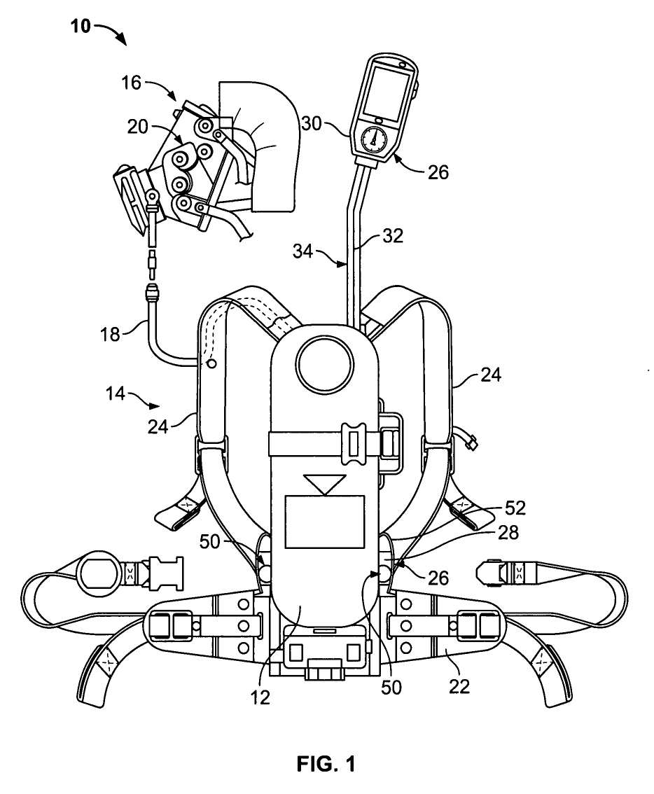

FIG. 1 is a perspective view of an exemplary mobile emergency system 10 carried by a firefighter or another emergency services worker. The system 10 may include a collection of firefighting or safety equipment, including, but not limited to, a high-pressure air tank 12, mounted on a backpack 14, as well as headgear 16 that is worn on the user's head and connected to the air tank 12 by an air supply line 18. The line 18 supplies breathable air from the air tank 12 to the user's mouth and nose. Optionally, the line 18 may supply power and/or data communications to a heads-up display 20. The backpack 14 includes a belt 22 and shoulder straps 24.

The system 10 includes a Personal Alert Safety System (“PASS”) 26. Optionally, the PASS 26 may include both a PASS unit 28 and a separate PASS control console 30. The PASS unit 28 may be carried in a recess in the user's backpack 14, while the PASS control console 30 hangs from the end of a pressure and/or data line 32, connected via a pressure reducer to the air tank 12, and a reinforced electronics cable sheath 34. The sheath 34 includes an electronics cable that interconnects the PASS unit 28 to the PASS control console 30. In the example of FIG. 1, the PASS 26 is shown to be distributed at two locations within the system 10, namely at the end of the pressure and/or data line 32 and at the base of the tank 12 on the belt 22. Optionally, the PASS unit 28 and the PASS control console 30 may be co-located within the system 10.

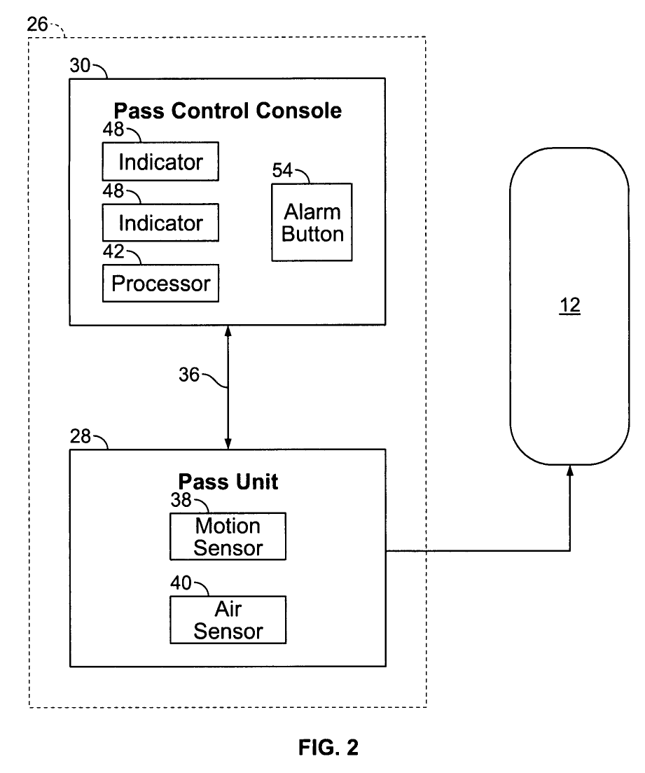

FIG. 2 is a block diagram of an exemplary embodiment of the PASS 26. The PASS control console and unit 30 and 28, respectively, are interconnected through a communications bus 36 that is provided within the electronic cable sheath 34 (FIG. 1). The PASS unit 28 includes a motion sensor 38 and an air sensor 40. The motion sensor 38 detects motion of the system 10, while the air sensor 40 detects the air pressure in the tank 12. The PASS control console 30 includes a processor 42, and a plurality of user indicators 48, such as, but not limited to, light emitting diodes (LEDs). The processor 42 receives signals from the motion sensor 38 and the air sensor 40, respectively, in the PASS unit 28 over the communications bus 36. Optionally, the motion sensor 38 and/or the air sensor 40 may be provided within the PASS control console 30. When the air sensor 40 is located at the PASS control console 30, an air pressure line is provided between the tank 12 and the PASS control console 30. Optionally, the user indicators 48 may display a status of the PASS 26, such as, but not limited to, displaying in red when in the PASS 26 is in alarm and displaying in green when the PASS 26 is in a normal status.

Referring to FIGS. 1 and 2, the PASS 26 includes a sounder assembly 50 for generating an audible alarm. In the exemplary embodiment, the sounder assembly 50 is held by the PASS unit 28, such as, but not limited to, being mounted on a housing 52 of the PASS unit 28. Alternatively, the sounder assembly 50 is carried by the PASS control console 30. As will be described in more detail below, the sounder assembly 50 is operatively connected to the processor 42. In the exemplary embodiment, and for example, the sounder assembly 50 may be activated to generate the audible alarm when a user activates an alarm button 54 on the PASS control console 30, when the processor 42 receives a signal from the motion sensor 38 that the user has not moved in a predetermined amount of time (such as, but not limited to, between approximately 20 seconds and approximately one minute), and/or when the processor 42 receives a signal from the air sensor 40 that the air pressure in the tank 12 is below a predetermined threshold (such as, but not limited to, between approximately 1 psi and approximately 1000 psi). Additionally or alternatively, the PASS unit 28 may include the alarm button 54.

A visible alarm may also be generated, for example using the user indicators 48, when the user activates an alarm button 54, when user has not moved in a predetermined amount of time, and/or when the air pressure in the tank 12 is below the predetermined threshold.

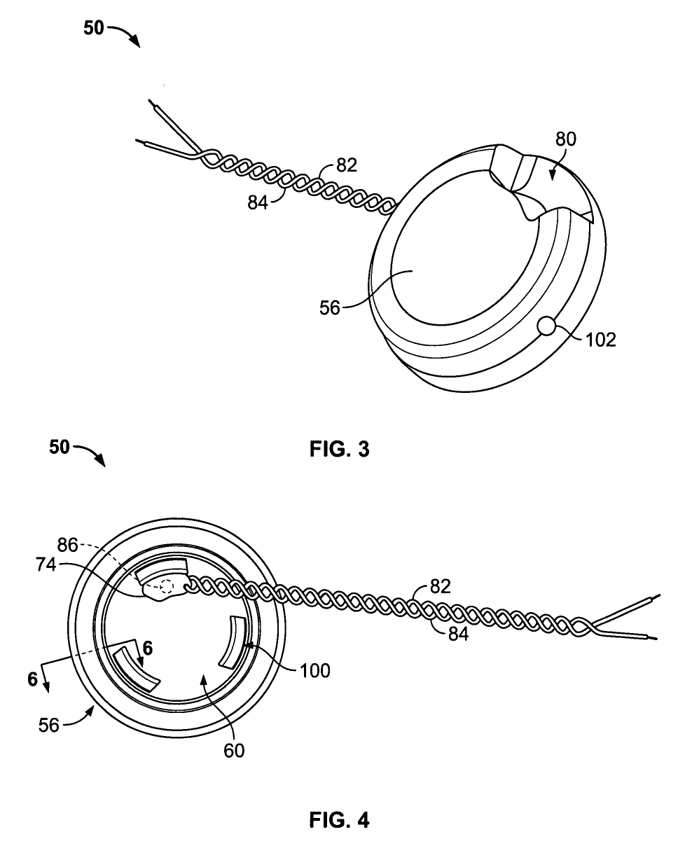

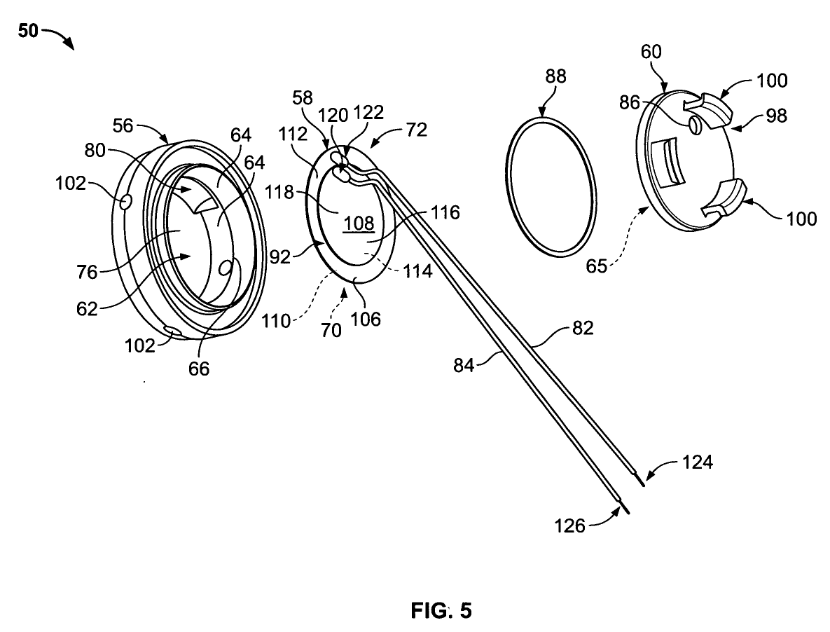

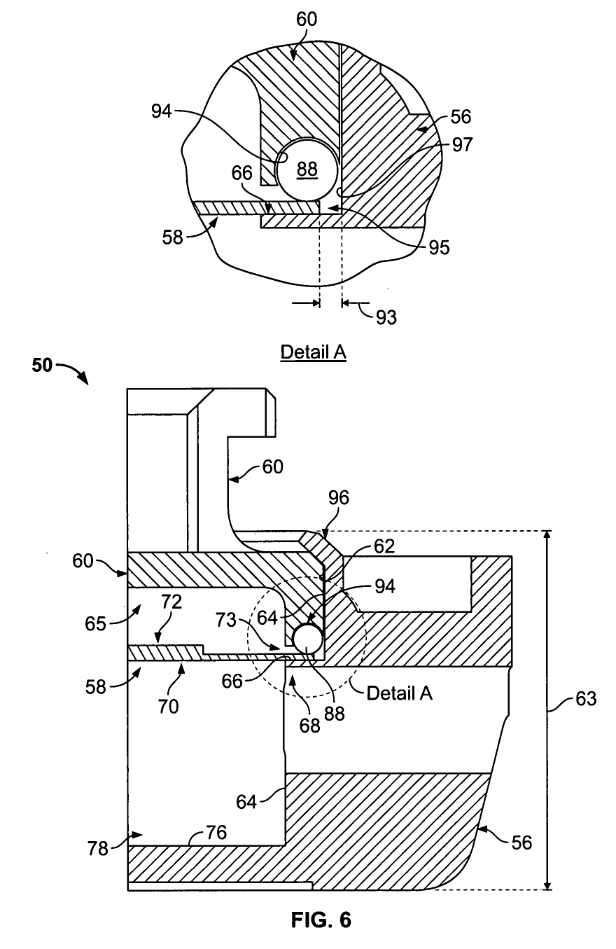

FIG. 3 is a top perspective view of an exemplary embodiment of the sounder assembly 50. FIG. 4 is a bottom plan view of the sounder assembly 50. FIG. 5 is an exploded perspective view of the sounder assembly 50. FIG. 6 is a cross section of a portion of the sounder assembly 50 taken along the line 6-6 of FIG. 4. The sounder assembly 50 includes a housing 56, a piezoelectric assembly 58, and a mounting member 60. The housing 56 includes a central opening 62 extending through a portion of a length 63 of the housing 56. A radially interior surface 64 of the housing 56 that defines the opening 62 includes a ledge 66. The piezoelectric assembly 58 is received within the opening 62 and a perimeter portion 68 of a side portion 70 of the assembly 58 engages the ledge 66 such that the ledge 66 supports the assembly 58 within the opening 62. A side portion 65 of the mounting member 60 is positioned over a side portion 72 of the piezoelectric assembly 58 that is opposite the side portion 70. The mounting member 60 is mounted on the housing 56 such that the mounting member 60 is partially received within the opening 62 of the housing 56 and engages a perimeter portion 73 of the side portion 72 of the piezoelectric assembly 58. An o-ring 88 is positioned between a perimeter portion 90 of the side portion 65 of the mounting member 60 and a perimeter portion 92 of the side portion 72 of the piezoelectric assembly 58. Specifically, the perimeter portion 90 of the side portion 65 of the mounting member 60 includes a groove 94 that at least partially receives the o-ring 88. The piezoelectric assembly 58 is sandwiched between the mounting member 60 and the housing ledge 66 and the o-ring 88 is compressed between the mounting member 60 and the piezoelectric assembly 58. As such, the piezoelectric assembly 58 is compressively held in the housing 56 between the housing ledge 66 and the mounting member 60. As can be seen in detail A of FIG. 6, a radial gap 93 is defined between a peripheral edge portion 95 of the piezoelectric assembly 58 and an interior wall 97 of the housing 56 that intersects the ledge 66 to accommodate radial contraction of the housing 56 relative to the piezoelectric assembly 58, as will be described below.

When in an unsupported state (e.g., when the assembly 58 is not held in the housing 56 or by anything else in a manner that would increase the tension across the surface 110 of the assembly 58), the piezoelectric assembly 58 has a natural tension extending across the surface 110 thereof. When the piezoelectric assembly 58 is compressively held in the housing 56 as discussed above, the compressive engagement may increase the tension extending across the surface 110 of the assembly 58 slightly above its natural tension due to a small amount of extrusion of the portions of the assembly 58 that are engaged by the housing 56 and the o-ring 88. The amount by which the natural tension of the surface 110 of the assembly 58 is increased by being compressively held in the housing 56 may be controlled by selecting the amount of compressive force applied between the mounting member 60 and the housing ledge 66 when the mounting member 60 is mounted on the housing 56, and/or by selecting the elasticity of the o-ring 88 and/or the amount of resistance of the o-ring 88 to compression.

The o-ring 88 may facilitate sealing the engagement between the mounting member 60 and the side portion 72 of the piezoelectric assembly 58. Optionally, the o-ring 88 may be lubricated within any suitable lubricant.

A space defined between the side portion 70 of the piezoelectric assembly 58 and a bottom wall 76 of the opening 62 forms a sound chamber 78. As described in more detail below, sound is generated in the sound chamber 78 when portions of the sounder assembly 50, including the piezoelectric assembly 58, are oscillated to generate the audible alarm. An opening 80 that extends through the housing 56 and communicates with the sound chamber 78 enables sound generated within the sound chamber 78 to be emitted from the sounder assembly 50. The sounder assembly 50 may generate an audible alarm of any suitable output, such as, but not limited to, between approximately 95 decibels and approximately 110 decibels.

As will be described in more detail below, a pair of electrical leads 82 and 84 are electrically connected to the piezoelectric assembly 58 to enable oscillation of portions of the sounder assembly 50. The leads 82 and 84 extend through an opening 86 extending through the mounting member 60 for electrical connection to the processor 42 (FIG. 2). Optionally, the opening 86 may be sealed using any suitable material(s) 74, such as, but not limited to, an epoxy.

The mounting member 60 may be mounted on the housing 56 using any suitable configuration, arrangement, method, process, structure, means, and/or the like, such as, but not limited to, using an adhesive, threaded and/or other fasteners, a snap-fit arrangement, and/or the like. In the exemplary embodiment, the mounting member 60 is mounted on the housing 56 using a snap-fit arrangement. Specifically, the housing 56 includes a deflectable latch 96 that engages the mounting member 60 to hold the mounting member 60 on the housing 56 and to retain the compressive engagement of the piezoelectric assembly 58 with the housing ledge 66 and the mounting member 60. A latch force provided by the latch 96 may be selected to hold the mounting member 60 on the housing 56 with a compression force between the mounting member 60 and the housing ledge 66 that enables the sounder assembly 50 to generate a predetermined audible alarm output. Although the housing 56, the piezoelectric assembly 58, and the mounting member 60 are illustrated herein having a generally circular shape, the housing 56, the piezoelectric assembly 58, and the mounting member 60 may each have any suitable shape that enables the sounder assembly 50 to function as described herein.

In the exemplary embodiment, a side portion 98 of the mounting member 60 includes bayonet attachment structures 100 for mounting the sounder assembly 50 to the housing 52 (FIG. 1) of the PASS unit 28 (FIGS. 1 and 2) using a bayonet-type attachment. However, the sounder assembly 50 may mount on the housing 52 using any suitable configuration, arrangement, method, process, structure, means, and/or the like. Alternatively, the mounting member 60 may be a portion of the housing 52 of the PASS unit 28 or may be a portion of a housing 99 (FIG. 1) of the PASS control console 30 (FIGS. 1 and 2).

The housing 56 may optionally include one or more holes 102 that extend through the housing 56 and communicate with the sound chamber 78 to enable fluid to drain from the sound chamber 78. In the exemplary embodiment, the sound chamber 78 includes a radial pattern of three holes 102. The holes 102 are spaced radially apart from each other along the housing 56 by approximately 90° and the pattern is arranged generally radially opposite the opening 80. The exemplary pattern of the holes may facilitate enabling the sound chamber 78 to drain fluid when the sounder assembly 50 is in any orientation. Although three holes 102 are illustrated, the housing 56 may include any number of holes. Moreover, the holes 102 may be arranged in any suitable pattern, with any suitable radial spacing angle(s), whether such pattern and radial spacing is uniform, radially or otherwise. Furthermore, although the holes 102 are shown as generally cylindrical, the holes 102 may have any suitable shape that enables the holes 102 to function as described herein.

The piezoelectric assembly 58 includes a support member 106, a piezoelectric member 108 laminated to the support member 106, and the electrical leads 82 and 84. The support member 106 includes a pair of opposite surfaces 110 and 112. The surface 110 defines the side portion 70 of the piezoelectric assembly 58. As will be described in more detail below, the piezoelectric member 108 is fabricated from a material(s) having piezoelectric properties. In some embodiments, the material(s) of the piezoelectric member 108 is polarized to provide the material with the piezoelectric properties. The piezoelectric member 108 includes a pair of opposite surfaces 114 and 116. The piezoelectric member 108 is laminated to the support member 106 such that the surface 114 faces the surface 112 of the support member 106. The surface 116 of the piezoelectric member 108 includes an electrode layer 118 at least partially coating the surface 116 to enable electrical connection between the lead 84 and the piezoelectric member 108. The electrode layer 118 may be fabricated from any suitable electrically conductive material(s) that enable the sounder assembly to function as described herein. An end portion 120 of the lead 82 is electrically connected to the surface 112 of the support member 106 and an end portion 122 of the lead 84 is electrically connected to the electrode layer 118 of the piezoelectric member 108. End portions 124 and 126 of the leads 82 and 84, respectively, are electrically connected to the processor 42 for receiving a voltage, as will be described below.

The leads 82 and 84 may be electrically connected to the support and piezoelectric members 106 and 108, respectively, using any suitable method, process, structure, means, and/or the like, such as, but not limited to solder. The connection between the leads 82 and 84 and the support and piezoelectric members 106 and 108, respectively, may be encapsulated with any suitable electrically insulating material(s), such as, but not limited to, an epoxy.

The piezoelectric member 108 may be laminated to the support member 106 using any suitable method, process, structure, means, and/or the like, such as, but not limited to, using an adhesive and/or heat. In some embodiments, it may be desired that the sounder assembly 50 remains operational up to a predetermined temperature and/or within predetermined temperature range, such as, but not limited to, between approximately −50° C. and approximately 500° C., between approximately 50° C. and approximately 400° C., between approximately 100° C. and approximately 300° C., or up to approximately 260° C. Accordingly, in some embodiments adhesive used to laminate the piezoelectric member 108 to the support member 106 may be rated for use above a predetermined temperature and/or within a predetermined temperature range, such as, but not limited to, between approximately −50° C. and approximately 500° C., between approximately 50° C. and approximately 400° C., between approximately 100° C. and approximately 300° C., or up to approximately 260° C. In the exemplary embodiment, an adhesive having a temperature rating above approximately 259° C. is used to laminate the piezoelectric member 108 to the support member 106.

Although shown as generally circular, the support member 106 and the piezoelectric member 108 may each have any suitable shape than enables the support member and the piezoelectric member 108 to function as described herein.

As described above, in some embodiments it may be desired that the sounder assembly 50 remains operational up to a predetermined temperature and/or within predetermined temperature range, such as, but not limited to, between approximately −50° C. and approximately 500° C., between approximately 50° C. and approximately 400° C., between approximately 100° C. and approximately 300° C., or up to approximately 260° C. The piezoelectric assembly 58 has a different thermal coefficient of expansion than the housing 56 and the mounting member 60 because the piezoelectric assembly 58 is fabricated from different materials than the housing 56 and the mounting member 60. The housing 56 and the mounting member 60 are selected to have a thermal coefficient of expansion that is greater than the thermal coefficient of expansion of the piezoelectric assembly 58. Accordingly, when the various components of the sounder assembly 50 expand due to an increase in the temperature environment of the sounder assembly 50, the housing 56 and the mounting member 60 radially expand a greater amount than the piezoelectric assembly 58. Specifically, because the piezoelectric assembly 58 is compressively held in the housing 56 without being bonded thereto with an adhesive, the housing 56 and the mounting member 60 radially expand relative to the piezoelectric assembly 58 such that the o-ring 88 and the perimeter portion 90 of the mounting member 60 move radially outward across the perimeter portion 73 of the side portion 72 of the piezoelectric assembly 58, and such that the housing ledge 66 moves radially outward across the perimeter portion 68 of the side portion 70 of the assembly 58. Likewise, when the various components of the sounder assembly 50 contract due to a decrease in the temperature environment of the sounder assembly 50, the housing 56 and the mounting member 60 radially contract a greater amount than the piezoelectric assembly 58. Specifically, the housing 56 and the mounting member 60 radially contract relative to the piezoelectric assembly 58 such that the o-ring 88 and the perimeter portion 90 of the mounting member 60 move radially inward across the perimeter portion 73 of the side portion 72 of the piezoelectric assembly 58, and such that the housing ledge 66 moves radially inward across the perimeter portion 68 of the side portion 70 of the assembly 58. Because of the radial expansion and contraction of the housing 56 relative to the piezoelectric assembly 58, the radial gap 93 defined between the peripheral edge portion 95 of the piezoelectric assembly 58 and the interior wall 97 of the housing 56 varies in size based on temperature changes.

Because the housing 56 and the mounting member 60 radially expand and contract relative to the piezoelectric assembly, the tension across the surface 110 of the piezoelectric assembly 58 does not change as a result of temperature changes as much as it would if it was bonded to the housing 56 and/or the mounting member 60. In some embodiments, when the sounder assembly 50 is exposed to temperatures between approximately −50° C. and approximately 260° C., the tension across the surface 110 of the piezoelectric assembly 58 remains within approximately 10% of the initial tension at the time of manufacture such that the output of the audible alarm remains within approximately 10 decibels of the initial sound output at the time of manufacture.

The support member 106 may be fabricated from any suitable material(s) that enable the sounder assembly 50 to function as described herein, such as, but not limited to, metals or other electrically conductive materials. In some embodiments, the support member 106 is fabricated from a material(s) that has a thermal coefficient of expansion of less than approximately 7×10⁻⁶/K between a range of between approximately 0° C. and approximately 260° C. For example, in the exemplary embodiment, the support member 106 is fabricated from a foil of Kovar, which typically has a thermal coefficient of expansion of between approximately 4×10⁻⁶/K and 6×10⁻⁶/K between a range of between approximately 0° C. and approximately 300° C. Another example of the support member 106 includes, but is not limited to, Invar, which typically has a thermal coefficient of expansion of between approximately 1×10⁻⁶/K and 2×10⁻⁶/K at 20° C.

The piezoelectric member 108 may be fabricated from any suitable material(s) that enables the piezoelectric member 108 to have piezoelectric properties and that enables the sounder assembly 50 to function as described herein, such as, but not limited to, ceramics. In some embodiments, the piezoelectric member 108 is fabricated from a material(s) that has a thermal coefficient of expansion of less than approximately 7×10⁻⁶/K between a range of between approximately 0° C. and approximately 260° C. Moreover, in some embodiments, the piezoelectric member 108 is fabricated from a material(s) that has a thermal coefficient of expansion of less than approximately 2×10⁻⁶/K between a range of between approximately 0° C. and approximately 260° C. In the exemplary embodiment, the support member 106 is fabricated from a ceramic, such as, but not limited to, ceramic part number 200458-01, commercially available from Piezo Technologies of Indianapolis, Ind. In some embodiments, the support member 106 and the piezoelectric member 108 each have a thermal coefficient of expansion that is within a predetermined amount of each other, such as, but not limited to, within approximately 10% of each other or within approximately 5% of each other.

The housing 56 may be fabricated from any suitable material(s) that enable the sounder assembly 50 to function as described herein, such as, but not limited to, metals. In some embodiments, the housing 56 is fabricated from a material(s) that has a thermal coefficient of expansion of less than approximately 20×10⁻⁶/° C. between a range of between approximately 0° C. and approximately 260° C. For example, in the exemplary embodiment, the housing 56 is fabricated from UNS S30300 stainless steel, which typically has a thermal coefficient of expansion of between approximately 17×10⁻⁶/° C. and 19×10⁻⁶/° C. at 20° C. Other examples of the housing 56 include, but are not limited to, other types of stainless steel or other metals.

The mounting member 60 may be fabricated from any suitable material(s) that enable the sounder assembly 50 to function as described herein, such as, but not limited to, metals. In some embodiments, the mounting member 60 is fabricated from a material(s) that has a thermal coefficient of expansion of less than approximately 20×10⁻⁶/° C. between a range of between approximately 0° C. and approximately 260° C. For example, in the exemplary embodiment, the mounting member 60 is fabricated from UNS S30300 stainless steel. Other examples of the housing 56 include, but are not limited to, other types of stainless steel and/or other metals.

To facilitate maintaining as small a change as possible of the tension across the surface 110 of the piezoelectric assembly 58 as compared to the initial tension at the time of manufacture, and/or to facilitate maintaining the sealing engagement between the mounting member 60 and the side portion 72 of the piezoelectric assembly 58, the thermal coefficients of expansion of the housing 56 and the mounting member may be selected to be within a predetermined amount of each other, such as, but not limited to, within approximately 10% of each other or within approximately 5% of each other.

In operation, when the sounder assembly 50 is activated to generate the audible alarm, the processor 42 applies a voltage to the piezoelectric assembly 58 via the leads 82 and 84. The voltage causes the piezoelectric assembly 58 to oscillate and thereby generate sound within the sound chamber 78. Oscillation of the piezoelectric assembly 58 may also cause oscillation of the housing 56 and/or the mounting member 60, which may contribute to the sound generation within the sound chamber 78. The sound generated within the sound chamber 78 is emitted by the sounder assembly 50 through the opening 80 of the housing 56.

The embodiments described and illustrated herein may provide a sounder assembly for a PASS that may be able to operate in higher temperatures conditions than at least some known sounder assemblies. The embodiments described and illustrated herein may allow a PASS to carry a reduced number of sounder assemblies.

Exemplary embodiments are described and/or illustrated herein in detail. The embodiments are not limited to the specific embodiments described herein, but rather, components and/or steps of each embodiment may be utilized independently and separately from other components and/or steps described herein. Each component, and/or each step of one embodiment, can also be used in combination with other components and/or steps of other embodiments. When introducing elements/components/etc. described and/or illustrated herein, the articles “a”, “an”, “the”, “said”, and “at least one” are intended to mean that there are one or more of the element(s)/component(s)/etc. The terms “comprising”, “including” and “having” are intended to be inclusive and mean that there may be additional element(s)/component(s)/etc. other than the listed element(s)/component(s)/etc. Moreover, the terms “first,” “second,” and “third,” etc. in the claims are used merely as labels, and are not intended to impose numerical requirements on their objects. Further, the limitations of the following claims are not written in means—plus-function format and are not intended to be interpreted based on 35 U.S.C. §112, sixth paragraph, unless and until such claim limitations expressly use the phrase “means for” followed by a statement of function void of further structure.

While the invention has been described in terms of various specific embodiments, those skilled in the art will recognize that the invention can be practiced with modification within the spirit and scope of the claims.

What is claimed is:

1. A sounder assembly for a personal alert safety system (PASS), said sounder assembly comprising:
a housing; and
a piezoelectric assembly compressively held in the housing such that a sound chamber is defined by the housing and the piezoelectric assembly, the housing radially expanding and contracting relative to the piezoelectric assembly based on temperature changes.

2. The sounder assembly according to claim 1, wherein a radial gap is defined between a peripheral edge portion of the piezoelectric assembly and an interior wall of the housing to accommodate radial expansion and contraction of the housing relative to the piezoelectric assembly, a size of the radial gap varying in length based on temperature changes.

3. The sounder assembly according to claim 1, further comprising a mounting member mounted on the housing, the piezoelectric assembly being compressively held in the housing between at least a portion of the housing and at least portion of the mounting member.

4. The sounder assembly according to claim 1, further comprising a mounting member mounted on the housing such that the piezoelectric assembly is sandwiched between at least a portion of the housing and at least a portion of the mounting member, the housing comprising a deflectable latch that engages the mounting member to hold the mounting member on the housing and retain compressive engagement of the piezoelectric assembly with the housing and the mounting member.

5. The sounder assembly according to claim 1, wherein the piezoelectric assembly is compressively held in the housing without the use of an adhesive.

6. The sounder assembly according to claim 1, wherein a perimeter portion of the piezoelectric assembly engages a ledge of the housing such that the ledge at least partially supports the piezoelectric assembly.

7. The sounder assembly according to claim 1, further comprising a mounting member mounted on the housing such that the piezoelectric assembly is sandwiched between at least a portion of the housing and at least a portion of the mounting member, and an o-ring that is at least partially compressed between the mounting member and the housing.

8. The sounder assembly according to claim 1, further comprising a mounting member mounted on the housing such that the piezoelectric assembly is sandwiched between at least a portion of the housing and at least a portion of the mounting member, the mounting member having a thermal coefficient of expansion that is greater than a thermal coefficient of expansion of the piezoelectric assembly.

9. The sounder assembly according to claim 1, wherein the housing comprises stainless steel.

10. The sounder assembly according to claim 1, wherein the housing has a thermal coefficient of expansion that is greater than a thermal coefficient of expansion of the piezoelectric assembly.

11. The sounder assembly according to claim 1, wherein the piezoelectric assembly comprising a piezoelectric member laminated to a support member.

12. The sounder assembly according to claim 11, wherein the support member has a thermal coefficient of expansion of less than approximately 7×10⁻⁶/K at a temperature of between approximately 0° C. and approximately 260° C.

13. The sounder assembly according to claim 11, wherein the support member comprises one of Kovar and Invar.

14. The sounder assembly according to claim 11, wherein the support member has a thermal coefficient of expansion within about 10% of a thermal coefficient of expansion of the piezoelectric member.

15. The sounder assembly according to claim 1, wherein the housing comprises at least three openings that each communicate with the sound chamber, the openings being spaced radially apart from each other along the housing at approximately 90°.

16. A personal alert safety system (PASS) comprising:
a processor;
at least one of a pressure sensor and a motion sensor, the sensor being operatively connected to the processor; and
a sounder assembly comprising a housing and a piezoelectric assembly compressively held in the housing such that a sound chamber is defined by the housing and the piezoelectric assembly, the piezoelectric assembly being operatively connected to the processor for receiving a voltage therefrom, the housing radially expanding and contracting relative to the piezoelectric assembly based on temperature changes.

17. The PASS according to claim 16, wherein a radial gap is defined between a peripheral edge portion of the piezoelectric assembly and an interior wall of the housing to accommodate radial expansion and contraction of the housing relative to the piezoelectric assembly, a size of the radial gap varying in length based on temperature changes.

18. The PASS according to claim 16, further comprising a mounting member mounted on the housing, the piezoelectric assembly being compressively held in the housing between at least a portion of the housing and at least portion of the mounting member.

19. The PASS according to claim 16, further comprising a mounting member mounted on the housing such that the piezoelectric assembly is sandwiched between at least a portion of the housing and at least a portion of the mounting member, the housing comprising a deflectable latch that engages the mounting member to hold the mounting member on the housing and retain compressive engagement of the piezoelectric assembly with the housing and the mounting member.

20. The PASS according to claim 16, wherein the piezoelectric assembly is compressively held in the housing without the use of an adhesive.

21. The PASS according to claim 16, further comprising a mounting member mounted on the housing such that the piezoelectric assembly is sandwiched between at least a portion of the housing and at least a portion of the mounting member, and an o-ring that is at least partially compressed between the mounting member and the housing.

22. The PASS according to claim 16, further comprising a mounting member mounted on the housing such that the piezoelectric assembly is sandwiched between at least a portion of the housing and at least a portion of the mounting member, the mounting member having a thermal coefficient of expansion that is greater than a thermal coefficient of expansion of the piezoelectric assembly.

23. The PASS according to claim 16, wherein the housing has a thermal coefficient of expansion that is greater than a thermal coefficient of expansion of the piezoelectric assembly.

24. The PASS according to claim 16, further comprising a mounting member mounted on the housing such that the piezoelectric assembly is sandwiched between at least a portion of the housing and at least a portion of the mounting member, wherein the mounting member comprises stainless steel.

25. The PASS according to claim 16, further comprising a mounting member mounted on the housing such that the piezoelectric assembly is sandwiched between at least a portion of the housing and at least a portion of the mounting member, wherein the mounting member is a portion of a housing of the PASS or comprises at least one attachment member for mounting the sounder assembly to a housing of the PASS.
